(19) United States
(12) Patent Application Publication
(10) Pub. No.: US 2011/0006260 A1
(43) Pub. Date: Jan. 13, 2011

(54) PROCESS FOR MAKING BLEACH CO-PARTICLES

(76) Inventors: Nigel Patrick Somerville-Roberts, Newcastle (GB); Alan Thomas Brooker, Newcastle (GB); David James Parmley, Gateshead (GB); Victor Stuart Reid, Newcastle upon Tyne (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/832,429

(22) Filed: Jul. 8, 2010

Related U.S. Application Data
(60) Provisional application No. 61/224,179, filed on Jul. 9, 2009.

(51) Int. Cl. C11D 3/39

(52) U.S. Cl. 252/186.41

(57) ABSTRACT

Disclosed herein is a process for making a co-particle containing a hydrogen-peroxide bleaching system comprising the steps of contacting a hydrogen peroxide source with a binder to form a coated particle and contacting the coated particle with a coating powder to form a co-particle. Compositions containing the co-particle are also disclosed.

### CROSS REFERENCE TO RELATED APPLICATION

This application claims the benefit of U.S. Provisional Application Ser. No. 61/224,179, filed Jul. 9, 2009.

### FIELD OF THE INVENTION

Co-particles, compositions comprising said co-particles and methods of making and using same are disclosed.

### BACKGROUND OF THE INVENTION

While known bleaching systems provide a cleaning benefit, there remains the need for processes for making laundry compositions that provide improved cleaning benefits and/or that more efficiently use bleaching agents, and/or which can be a continuous process, and hence, better suited for large scale, rapid manufacture of product. One of the main factors that determines the processability and feasibility of any industrial process is the time taken for the process to be carried out. If the product needs to be made at a high rate and the manufacturing process takes a long time, the equipment required will of necessity be large, increasing costs and reducing viability. In contrast, the faster the process, the smaller the required equipment, and in turn, the easier the process will be to implement in a crowded industrial or detergent plant.

These issues are especially relevant to the production of coated particles such as coated percarbonate. Many of the coating and protective processes used to make and coat sodium percarbonate are not rapid processes, but rather, require batch processing, having batch times, in some instances of 15 minutes or more 20. See, e.g., U.S. Pat. No. 5,458,801, WO 2007/127641, published also as US20070252107A1. Such processes would require very large equipment if implemented at an industrial scale.

Further, methods related to coating percarbonate or layering powder cores often use aqueous solutions of materials such as borosilicates or sodium sulphate. These solutions contain water that must be dried from the resulting product. This drying step limits the rate at which the coating can be applied, and also constrains manufacturing procedures.

There is therefore a need for processes that can be used to coat particles such as percarbonate particles, which can be carried out rapidly and/or cost-efficiently.

### SUMMARY OF THE INVENTION

Co-particles, compositions comprising said co-particles and methods of making and using same are disclosed.

### DETAILED DESCRIPTION OF THE INVENTION

As used herein, articles such as “a” and “an” when used in a claim, are understood to mean one or more of what is claimed or described.

As used herein, the term “core,” as applied to a source of hydrogen peroxide such as percarbonate, includes the active agent itself in addition to any coating applied by the manufacturer.

As used herein, the term “gelling agent” means a material capable of forming a gel upon contact with water.

“Gel” as defined herein refers to a transparent or translucent liquid having a viscosity of greater than about 2000 mPa*s at 25° C. and at a shear rate of 20 sec-¹. In some embodiments, the viscosity of the gel may be in the range of from about 3000 to about 10,000 mPa*s at 25° C. at a shear rate of 20 sec-¹ and greater than about 5000 mPa*s at 25° C. at a shear rate of 0.1 sec-¹.

As used herein, the terms “include”, “includes” and “including” are meant to be non-limiting.

As used herein, the term “layer” means a partial or complete coating of a layering material built up on a particle's surface or on a coating covering at least a portion of said surface.

“Liquid” as defined herein refers to a liquid having a viscosity of less than about 2000 mPa*s at 25° C. and a shear rate of 20 sec-¹. In some embodiments, the viscosity of the pourable liquid may be in the range of from about 200 to about 1000 mPa*s at 25° C. at a shear rate of 20 sec-¹. In some embodiments, the viscosity of the pourable liquid may be in the range of from about 200 to about 500 mPa*s at 25° C. at a shear rate of 20 sec-¹.

“Paste” and “semi-solid” are used interchangeably, and are defined herein refer to compositions having a viscosity of greater than about 2000 mPa*s at 25° C. and a shear rate of 20 sec-¹. In some embodiments, the viscosity of the cream may be in the range of from about 3000 to about 20,000 mPa*s at 25° C. at a shear rate of 20 sec-¹, or greater than about 5000 mPa*s at 25° C. at a shear rate of 0.1 sec-¹.

As used herein, the term “solvent” is meant to connote a liquid portion that may be added to one or more components described herein. The term “solvent” is not intended to require that the solvent material be capable of actually dissolving all of the components to which it is added. Exemplary solvents include alkylene glycol mono lower alkyl ethers, propylene glycols, ethoxylated or propoxylated ethylene or propylene, glycerol esters, glycerol triacetate, lower molecular weight polyethylene glycols, lower molecular weight methyl esters and amides, and the like.

As used herein, “substantially free of” a component means that no amount of that component is deliberately incorporated into the composition.

As used herein, “particle size” refers to the diameter of the particle at its longest axis.

By “mean particle size” is meant the mid-point of the size distribution of the particles made herein, as measured by standard particle size analysis techniques.

As used herein, the term “situs” includes paper products, fabrics, garments, hard surfaces, hair and skin.

The term “residence time” as used herein, is a well known engineering concept applied to continuous flow systems, and is calculated by mathematically dividing the volume of liquid in a vessel by the flow rate into an out of the vessel such that the volume of liquid remains constant. For example, a flow rate of 5 ml/min into and out of a vessel containing 10 ml of liquid has a residence time of 2 minutes.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Applicants have recognized that it is possible to increase the speed of a particle coating process for the bleaching systems described above, wherein the process is capable of forming stable and effective layered particles without the production of excessive levels of unwanted oversize or fines. Without being bound by theory, it is believed that this can be achieved by selection of the appropriate binder—which is used to coat the particle and bind a layering powder to the particle—having certain chemical and rheological properties. For example, Applicants have recognized that useful binders have a viscosity that is low enough to allow the binder to be easily spread onto a core particle by moderate agitation, but which is not so low as to cause poor particle flow properties and special manufacturing procedures. Applicants have further recognized that the viscosity of the binder should be sufficiently high so as to effectively bind a layering powder onto the core particle, but within a viscosity range that avoids the formation of oversize and fines formation during the process. Applicants have further recognized that, using the disclosed processes, robust layered particles capable of being handled can be made.

Applicants have further recognized that use of a substantially non-aqueous binder offers significant processing advantages, for example, in that a drying step is not required. Applicants have further recognized that, by using a binder that remains a liquid or paste or a soft solid at room temperature, material left in the processing equipment after the process is stopped will not form a hard solid, thus avoiding problems when the equipment is restarted. Further, Applicants have recognized that the binders disclosed herein can be used at ambient temperatures, thus maximizing energy efficiency of the process as a whole, and reducing overall cost.

A process for making a co-particle comprising a source of hydrogen peroxide, comprising the steps of a) contacting a source of hydrogen peroxide with a binder that may be a liquid, gel, foam, or paste, in one aspect a liquid, gel, or paste, at 25° C. to form a coated particle; and b) contacting said coated particle with a coating powder to form a co-particle, wherein said co-particle comprises a core comprising said source of hydrogen peroxide and a layer comprising said binder and said coating powder, is disclosed.

In one aspect, the process may be free of a drying step. In another aspect, the process may be free of a cooling step. In another aspect, the binder may be used at a temperature of from about 15° C. to about 50° C., or about 20° C. to about 30° C.

In one aspect, the process may be a continuous process. In this aspect, the process may have a residence time of from about 10 seconds to about two minutes, or from about 20 seconds to one minute. In one aspect, steps (a) and (b) of the process may be carried out using a mixing screw, wherein the binder and the coating powder may be introduced into the process at different positions.

In one aspect, the source of hydrogen peroxide may be coated with binder two times, or three times, or four times, or more than four times.

In one aspect, the co-particles may be flowable.

In one aspect, steps (a) and (b) of the process may be carried out in the absence of a fatty acid.

In one aspect, the source of hydrogen peroxide may comprise a per-compound. The source of hydrogen peroxide may comprise a material selected from the group consisting of sodium perborate in mono-hydrate or tetra-hydrate form or mixtures thereof; sodium percarbonate; and combinations thereof. In one aspect, the source of hydrogen peroxide may be sodium percarbonate. In this aspect, the sodium percarbonate may be in the form of a coated percarbonate particle.

In one aspect, the binder may be contacted with the source of hydrogen peroxide such that the co-particle may comprise, based on total co-particle weight, from about 2% to about 15%, or from about 6% to about 10%, or about 7% of the co-particle. In one aspect, the binder may have a viscosity of from about 200 to about 20,000, or from about 500 to about 7,000, or from about 1,000 to about 2,000 centipoise at a shear rate of 25 sec⁻¹ and a temperature of 25° C. The binder may comprise, based on total binder weight, from about 0.001% to about 5%, or from about 0.5% to about 3%, or from about 1% to about 2% water. In one aspect, the binder may be substantially free of water. In another aspect, the binder may be capable of absorbing from about 0.01% to about 15%, or from about 0.1% to about 10%, or from about 1% to about 5% water by weight of the binder over a relative humidity of 80% at 32° C. In one aspect, the binder may have a pH, as measured as a 10% solution in water, of from about 3 to about 9, or from about 5 to about 8, or about 7. In one aspect, the binder may comprise a solvent.

In one aspect, the binder may comprise, based on total binder weight, from about 60% to about 100%, or about 70% to about 90%, of a non-surfactant material comprising a hydrocarbon material selected from the group consisting of fats, triglycerides, lipids, fatty acids, soft paraffin wax, and combinations thereof. In another aspect, the binder may comprise, based on total binder weight, from about 40% to about 100%, or from about 50% to about 99% of a surfactant material selected from the group consisting of anionic surfactant, nonionic surfactant, and combinations thereof. In one aspect, the surfactant material may comprise alcohol ethoxylate, linear alkylbenzene sulfonate surfactants, and combinations thereof.

In one aspect, the bleach activator may comprise a material selected from the group consisting of tetraacetyl ethylene diamine; oxybenzene sulphonate bleach activators, such as nonanoyl oxybenzene sulphonate; caprolactam bleach activators; imide bleach activators, such as N-nonanoyl-N-methyl acetamide; decanoyloxybenzenecarboxylic acid; amido-derived bleach activator; benzoxazin-type activator; acyl lactam activator; and combinations thereof. In one aspect, the bleach activator may comprise nonanoyl oxybenzene sulphonate (NOBS), tetraacetyl ethylene diamine (TAED), decanoyloxybenzenecarboxylic acid (DOBA), and combinations thereof. In another aspect, the bleach activator may comprise tetraacetyl ethylene diamine.

In one aspect, the bleach activator may comprise an amido-derived bleach activators of the formulae:

R¹N(R⁵)C(O)R²C(O)L or R¹C(O)N(R⁵)R²C(O)L

wherein as used for these compounds R¹ may be an alkyl group containing from about 6 to about 12 carbon atoms, R² may be an alkylene containing from 1 to about 6 carbon atoms, R⁵ is H or alkyl, aryl, or alkaryl containing from about 1 to about 10 carbon atoms, and L is any suitable leaving group. A leaving group is any group that is displaced from the bleach activator as a consequence of the nucleophilic attack on the bleach activator by the hydroperoxide anion. In one aspect, the leaving group may be oxybenzenesulfonate. In one aspect, the bleach activators may comprise (6-octanamido-caproyl)oxybenzenesulfonate, (6-nonanamidocaproyl)oxybenzene-sulfonate, (6-decanamido-caproyl)oxybenzenesulfonate, and mixtures thereof.

In one aspect, the bleach activator may comprise a bleach activator of the benzoxazin-type and may comprise:

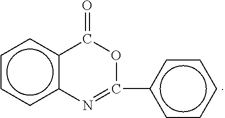

In one aspect, the bleach activator may be an acyl lactam activator of the formulae:

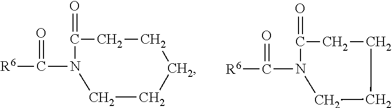

wherein as used for these compounds R⁶ may be H or an alkyl, aryl, alkoxyaryl, or alkaryl group containing from 1 to about 12 carbon atoms. In this aspect, the bleach activator may be acyl caprolactams and acyl valerolactams. In one aspect, the bleach activator may be selected from the group consisting of benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof. Non-limiting examples of suitable bleach activators are disclosed in U.S. Pat. Nos. 4,915,854, 4,412,934, 4,634,551, 4,966,723, 4,545,784

In one aspect, the coating powder may comprise a material selected from the group consisting of silicas; zeolites; amorphous aluminosilicates; clays; starches; celluloses; water soluble salts, such as an inorganic salt selected from the group consisting of sodium chloride, sodium sulphate, magnesium sulphate, sodium carbonate, sodium bicarbonate, and salts and mixtures thereof; polysaccharides including sugars; and combinations thereof.

In one aspect, the coating powder may have a median particle size of from about 1 μm to about 300 μm, or from about 3 μm to about 150 μm, or from about 10 μm to about 100, or from about 15 μm to about 80 μm.

In one aspect, the co-particle may comprise an additive selected from the group consisting of acidic materials; moisture sinks; gelling agents; antioxidants; and combinations thereof.

In one aspect, the additive may comprise an acidic material. In this aspect, the acidic material may be in the form of a powder material having a pKa of from about 4 to about 7, or from about 5 to about 6. In one aspect, the acidic material may be a powder material comprising ascorbic acid.

In one aspect, the additive may comprise a moisture sink. In this aspect, the moisture sink may be selected from the group consisting of crosslinked polyacrylates; sodium salts of maleic/acrylic copolymers; magnesium sulfate, or combinations thereof. In one aspect, the additive may comprise a gelling agent. The gelling agent may be selected from the group consisting of cellulose, including methylcellulose and CMC; alginate and derivatives thereof; starches; polyvinyl alcohols; polyethylene oxide; polyvinylpyrolidone; polysaccharides including chitosan and/or natural gums including carrageenan, xantham gum, guar gum, locust bean gum, and combinations thereof; polyacrylates including cross-linked polyacrylates; alcohol ethoxylates; lignosulfonates; surfactants and mixtures thereof; powdered anionic surfactants; and combinations thereof.

In one aspect, the additive may comprise an antioxidant. In this aspect, the antioxidant may be selected from the group consisting of phenolic antioxidants; amine antioxidants; alkylated phenols; hindered phenolic compounds; benzofuran or benzopyran; alpha-tocopherol, beta-tocopherol, gamma-tocopherol, delta-tocopherol, and derivatives thereof; 6-hydroxy-2,5,7,8-tetra-methylchroman-2-carboxylic acid; ascorbic acid and its salts; butylated hydroxy benzoic acids and their salts; gallic acid and its alkyl esters; uric acid and its salts and alkyl esters; sorbic acid and its salts; amines; sulfhydryl compounds; dihydroxy fumaric acid and its salts; and combinations thereof; or 2,6-di-tert-butylphenol; 2,6-di-tert-butyl-4-methylphenol; mixtures of 2 and 3-tert-butyl-4-methoxyphenol; propyl gallate; tert-butylhydroquinone; benzoic acid derivatives such as methoxy benzoic acid; methylbenzoic acid; dichloro benzoic acid; dimethyl benzoic acid; 5-hydroxy-2,2,4,6,7-pentamethyl-2,3-dihydro-1-benzofuran-3-one; 5-hydroxy-3-methylene-2,2,4,6,7-pentamethyl-2,3-dihydro-benzofuran; 5-benzyloxy-3-hydroxymethyl-2,2,4,6,7-pentamethyl-2,3-dihydro-1-benzofura-n, 3-hydroxymethyl-5-methoxy-2,2,4,6,7-pentamethyl-2,3-dihydro-1-benzofura-n; ascorbic acid; 1,2-dihydro-6-ethoxy-2,2,4-trimethylchinolin, and combinations thereof; or 2,6-di-tert-butyl hydroxy toluene; alpha-tocopherol; hydroquinone, 2,2,4-trimethyl-1,2-dihydroquinoline; 2,6-di-tert-butyl hydroquinone; 2-tert-butyl hydroquinone; tert-butyl-hydroxy anisole; lignosulphonic acid and salts thereof; benzoic acid and derivatives thereof; trimethoxy benzoic acid; toluic acid; catechol; t-butyl catechol; benzylamine; amine alcohols; 1,1,3-tris(2-methyl-4-hydroxy-5-t-butylphenyl)butane; N-propyl-gallate or mixtures thereof; or, in one aspect, di-tert-butyl hydroxy toluene.

In one aspect, the process may comprise the step of adding a detergent adjunct ingredient. Suitable adjunct detergent ingredients may be selected from the group consisting of a carbonate salt, a sulphate salt, a silicate salt, borosilicate, or mixtures thereof, including mixed salts; enzymes such as amylases, carbohydrases, cellulases, laccases, lipases, oxidases, peroxidases, proteases, pectate lyases and mannanases; suds suppressing systems such as silicone based suds suppressors; fluorescent whitening agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorohydrin; soil dispersants and soil anti-redeposition aids such as alkoxylated polyamines and ethoxylated ethyleneimine polymers; anti-redeposition components such as carboxymethyl cellulose and polyesters; perfumes; sulphamic acid or salts thereof; citric acid or salts thereof; and dyes such as orange dye, blue dye, green dye, purple dye, pink dye, or any mixture thereof.

In one aspect, a co-particle made according to the process described herein is disclosed.

In one aspect, a process of making a product comprising the co-particle described herein, comprising contacting the co-particle with a detergent adjunct material, is disclosed.

In one aspect, a product made according to the process described herein is disclosed.

In one aspect, a method of treating and/or cleaning a situs comprising the steps of a) optionally washing and/or rinsing said situs; b) contacting said situs with a co-particle and/or the product described herein; and c) optionally, washing and/or rinsing said situs is disclosed.

In one aspect, a situs treated with a co-particle or a product containing a co-particle as described herein, is disclosed.

### Test Methods

Binder Component Viscosity Test—This test method must be used to determine binder component viscosity. Viscosity is determined using a Paar Physica UDS 200 using a Z3 cup and spindle at 25° C. in accordance with the manufacturer's instructions. As described in the method, a viscometer of type “A” is applicable to the range of viscosity cited in the current work.

Determination of Degree of Hygroscopicity—A petri dish having a diameter of 10 cm is weighed on a balance having four decimal places. 10 grams of test binder is added to the petri dish. The petri dish containing binder is then placed at 80% relative humidity at 32° C. for 24 hours. The petri dish containing binder is then weighed again. The degree of hygrosopicity is represented as % increase in weight of the binder, and is calculated as [(weight of binder_{final}−weight of binderᵢₙᵢₜᵢₐₗ)/10 g]×100%.

Coating Powder Median Particle Size Test—The coating powder particle size test is determined in accordance with ISO 8130-13, “Coating powders—Part 13: Particle size analysis by laser diffraction.” A suitable laser diffraction particle size analyzer with a dry-powder feeder can be obtained from Horiba Instruments Incorporated of Irvine, Calif., U.S.A.; Malvern Instruments Ltd of Worcestershire, UK; Sympatec GmbH of Clausthal-Zellerfeld, Germany; and Beckman-Coulter Incorporated of Fullerton, Calif., U.S.A. The results are expressed in accordance with ISO 9276-1:1998, “Representation of results of particle size analysis—Part 1: Graphical Representation,” FIG. A.4, “Cumulative distribution Q₃ plotted on graph paper with a logarithmic abscissa.” The median particle size is defined as the abscissa value at the point where the cumulative distribution (Q₃) is equal to 50 percent.

### EXAMPLES

### Example I

### Preparation of Propandiol Binder

72 grams of micronized sodium carbonate, d50 of 20 microns, is dispersed into 600 g of propanediol, available from VWR, using a high shear mixer for 1 min. The propanediol and carbonate mixture is transferred into the bowl of a Kenwood Chef kMixer. 400 g of HLAS, available from Sasol, (˜60° C.) is slowly added to the propanediol and carbonate with the mixer on at setting of 3-4 to avoid excessive foaming. After addition of HLAS, the mix is allowed to mix for 1 minute. The mix is then allowed to de-aerate in a 60° C. oven. Any unreacted carbonate at the bottom of the mix is separated off. The pH is then adjusted to between 4 to 10 by addition of carbonate or HLAS. The mix is then de-aerated as above, and any further unreacted carbonate is separated from the mix. The final pH of the mix is between 5 and 6.

### Example II

### Preparation of Nonionic/LAS Binder

72 g micronized carbonate, d50 of 20 microns, is mixed into 600 g Neodol 45-7, available from Shell Chemicals, (nonionic surfactant) using a high shear mixer for 1 min. The nonionic/carbonate blend is transferred into the bowl of a Kenwood Chef kMixer. 400 grams of HLAS is slowly added into the nonionic/carbonate blend using continuous mixing for five minutes. 300 g magnesium sulphate is added to the HLAS/nonionic/carbonate mixture and stirred for 10 minutes. The pH is then adjusted to between 4 to 10 by addition of either carbonate or HLAS. The mix is then de-aerated as above, and any further unreacted carbonate is separated from the mix. The final pH of the mix is between 5 and 6

### Example III

### Preparation of Co-Particles

400 g of sodium percarbonate (Ecox-C™, available from Kemira, Finland) is mixed with 20.4 g of the propanediol binder in a Braun K 700 Food Processor until the mixture is visibly sticky. 200 g of TAED (Mykon™) Powder, available from Warwick International, Mostyn, Flintshire, U.K.) is then added. A further 12.3 g of the binder is then added with mixing. 30.5 g of carboxymethylcellulose, available under the tradename Finnfix® CMC, from CP Kelco is then added as a dusting agent to coat the particle.

### Example IV

### Preparation of Co-Particles

400 g of sodium percarbonate (Ecox-C™, available from Kemira, Finland) is mixed with 24 g of the nonionic/LAS binder in a Braun K 700 Food Processor until the mixture is visibly sticky. 200 g of TAED (Mykon®) Powder, available from Warwick International, Mostyn, Flintshire, U.K.) is then added. A further 11 g of binder is then added with mixing. 30.5 g carboxymethylcellulose, available under the tradename Finnfix® CMC, from CP Kelco is then added as a dusting agent to coat the particle.

### Example V

### Preparation of Co-Particles

5.9 kilograms of Kamira Ecox-C™ is added into a Bella XM20 Mixer, supplied by Dynamic Air, and agitated at a speed of 147 rpm. 800 g of the binder prepared according Example II is poured into the mixer over a period of 15 seconds. Five seconds after the start of the addition of the liquid binder, 3 kg of TAED powder is added over a period of 15 seconds followed by 300 g of carboxymethylcellulose, available under the tradename Finnfix® CMC, from CP Kelco for a total mix time of 23 seconds. The resulting co-particles are collected and sieved through a 1.7 mm grid and have an oversize level of less than 1%.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a co-particle comprising the steps of
a. contacting a hydrogen peroxide source with a binder, that is a liquid, gel, foam, or paste at 25° C., to form a coated particle comprising a core that comprises said hydrogen peroxide source and a coating comprising said binder;
b. contacting said coated particle with a coating powder to form a co-particle, wherein said co-particle comprises a core comprising said hydrogen peroxide source and a coating comprising said binder and said coating powder.

2. A process according to claim 1 wherein said process is free of a drying step.

3. A process according to claim 1 wherein said process is free of a cooling step.

4. A process according to claim 1 wherein said binder is applied to said hydrogen peroxide source at a temperature of from about 15° C. to about 50° C.

5. A process according to claim 1, said process being continuous.

6. A process according to claim 5 wherein said process has a residence time of from about 10 seconds to about two minutes.

7. A process according to claim 1 wherein steps (a) and (b) are conducted using a mixing screw, wherein said binder and said coating powder are introduced into the process at different positions.

8. A process according to claim 1, wherein said hydrogen peroxide source comprises a per-compound.

9. A process according to claim 1 wherein said binder is contacted with the hydrogen peroxide source such that the co-particle comprises, based on total co-particle weight, from about 2% to about 15% of the binder.

10. A process according to claim 1 wherein said binder has a viscosity of from about 200 to about 20,000 centipoise at a shear rate of 25 sec⁻¹ at a temperature of 25° C.

11. A process according to claim 1, wherein said binder comprises, based on total binder weight, from about 0.001% to about 5% water.

12. A process according to claim 1 wherein said binder is capable of absorbing from about 0.01% to about 15% water by weight of said binder over a relative humidity of 80% at 32° C.

13. A process according to claim 1 wherein said binder has a pH, as measured as a 10% solution in water, of from about 3 to about 9.

14. A process according to claim 1, wherein said binder comprises based on total binder weight, from about 60% to about 100% of a non-surfactant material comprising a hydrocarbon material selected from the group consisting of fats, triglycerides, lipids, fatty acids, soft paraffin wax, and combinations thereof.

15. A process according to claim 1, wherein said binder comprises, based on total binder weight, from about 40% to 100% of a surfactant material selected from the group consisting of anionic surfactant, nonionic surfactant, and combinations thereof.

16. A process according to claim 1 wherein said coating powder comprises a bleach activator comprising a material selected from the group consisting of tetraacetyl ethylene diamine; oxybenzene sulphonate bleach activators; caprolactam bleach activators; imide bleach activators; decanoyloxybenzenecarboxylic acid; amido-derived bleach activators; benzoxazin-type activators; acyl lactam activators; and combinations thereof.

17. A process according to claim 1 wherein said coating powder comprises a bleach activator comprising a material selected from the group consisting of sodium-nonaolyloxy benzene sulfonate, tetraacetyl ethylene diamine, and combinations thereof.

18. A process according to claim 1 wherein said coating powder comprises a material selected from the group consisting of silicas; zeolites; amorphous aluminosilicates; clays; starches; celluloses; water soluble salts; polysaccharides including sugars; and combinations thereof.

19. A process according to claim 1 wherein the coating powder has a median particle size of from about 1 μm to about 300 μm.

20. A process according to claim 1 wherein said co-particle comprises an additive selected from the group consisting of acidic materials; moisture sinks; gelling agents; antioxidants; and combinations thereof.

21. A process according to claim 1 comprising the step of adding an adjunct ingredient.

22. A co-particle made according to the process of claim 1.

23. A process of making a product comprising the co-particle of claim 23, comprising contacting the co-particle with a detergent adjunct material.

24. A method of treating a situs comprising contacting said situs with the co-particle of claim 23.
